(19) United States
(12) Patent Application Publication
(10) Pub. No.: US 2022/0016648 A1
(43) Pub. Date: Jan. 20, 2022

(54) CONSTRUCTIVE ARRANGEMENT APPLIED TO ELECTROSTATIC SPRAY NOZZLES FOR AGRICULTURAL AIRCRAFT AND HELICOPTERS

(71) Applicant: TRAVICAR TECNOLOGIA AGRÍCOLA LTDA, Porto Alegre (BR)

(72) Inventor: Felipe André Boris, Porto Alegre (BR)

(21) Appl. No.: 17/340,552

(22) Filed: Jun. 7, 2021

(30) Foreign Application Priority Data
Jul. 18, 2020 (BR) 202020014690-0

(51) Int. Cl. B05B 5/043

(52) U.S. Cl. CPC B05B 5/043

(57) ABSTRACT

Constructive arrangement applied in an electrostatic spray nozzle for aircraft and helicopters, equipped with electrode insulation fins, a diffuser core with a dosing disc and a fan dosing tip with regulation for a conical jet and flat jet.

### BACKGROUND OF THE INVENTION

The following utility model refers to the constructive arrangement applied in an electrostatic spray nozzle for aircraft and helicopters, equipped with electrode insulation fins, a diffuser core with a dosing disc and a fan dosing tip with regulation for a conical jet and flat jet.

### DESCRIPTION OF THE STATE OF THE ART

Conventional spraying is similar to electrostatic spraying, with the difference that in the last one the drops are electrically charged, which significantly increases the efficiency of the system. This type of equipment has the capacity of general drops with a high intensity of static electric charge, so that these electrified drops when approaching any object, for example, a leaf, form a large electrostatic field, inducing the appearance of forces of attraction between the drops and the leaf.

As the force of electrical attraction is greater than the force of gravity, the drops are able to deposit on all parts of the plant, even on the underside of the leaves, where a high concentration of pests occurs.

The equipment works by electrifying the spray liquid. For electrification to occur, it is necessary to use an induction electrode that is positioned a few millimeters from the liquid, at the point where it breaks into drops, achieving a very intense electrostatic field with relatively low voltages. However, the biggest problem with this method is that the droplets produced have polarity opposite to the induction electrode and thus they are strongly attracted to deposit on their surface, causing their wetness to the drip point. The presence of liquid on the surface of the induction electrode generates ionization points, which discharge the formed drops or generate electrical sparks, reducing the effectiveness of the nozzle.

The electrostatic nozzles used in aircraft do not have insulating fins, this can be seen in document CN201073624 which describes a nozzle cone, an anterior nozzle body, a nozzle body and a check valve; two nozzles are formed with two transverse communication tubes and a “T” fitting communicated with the transverse spout that is arranged on the plane; an electrode is disposed around the nozzle cone; the metal electrodes of the two nozzles are connected to the positive and negative outputs of the corresponding HVDC switching power supply. The utility model is mainly used in agricultural airplanes, in particular in the aviation electrostatic sprinkler system, which can produce both positive and negative high voltage electrostatics at the same time.

Another spray nozzle for aircraft can be seen in document US 20130068862, which describes an apparatus for spraying and inducing an electrostatic charge on a liquid above 0.8 milliliters/kg is connectable to a boom installed in a vehicle, such as an aircraft, with a DC power supply. The apparatus comprises a nozzle constructed from a substantially non-conductive material and includes a spray tip designed to provide a hollow tapered spray pattern. A support member extends from the nozzle and supports a charging electrode to induce an electrostatic charge in the liquid sprayed through the nozzle. The charge electrode is connected to the support member and is electrically connectable to the dc power supply. The charging electrode includes a cylindrical portion and a plurality of crown discharge members extending inwardly from a distal end of the cylindrical portion adjacent the spray tip. The charging electrode is positioned to allow the hollow conical spray pattern to pass unimpeded through it.

The electrostatic nozzle used in aircraft is very susceptible to clogging due to the exclusive use of ceramic to form drops. In this version, it was possible to eliminate clogging with the use of a diffuser core and dosing disc. In this way, dirt passes through the hole and does not obstruct the outlet and the formation of a drop. In many cases, it was necessary to end activities to clean the equipment.

Previous models were limited only to the use of ceramics for the formation of drop. In the developed model, it is possible to use a diffuser core with a ceramic dosing disc, in addition to a fan dosing tip, which allows electrostatic spraying in a conical or flat jet.

With the addition of new tips it is possible to spray with different volumes and with low pressure.

### DESCRIPTION OF THE DRAWINGS

The characterization of the present utility model is made by means of drawings representative of the constructive arrangement applied in an electrostatic spray nozzle for aircraft and helicopters, in such a way that the product can be fully reproduced by appropriate technique, allowing full characterization of the functionality of the object claimed.

Based on the figures that express the best or preferential form of realizing the product now idealized, the descriptive part of the report is based, through a detailed and consecutive numbering, where it clarifies aspects that may be implied by the adopted representation to clearly determine the protection now sought.

These figures are merely illustrative and may present variations, as long as they do not run away from what was initially claimed.

This is the description of the drawings:

FIG. 1—shows a perspective and frontal view of the standard spray nozzle arrangement;

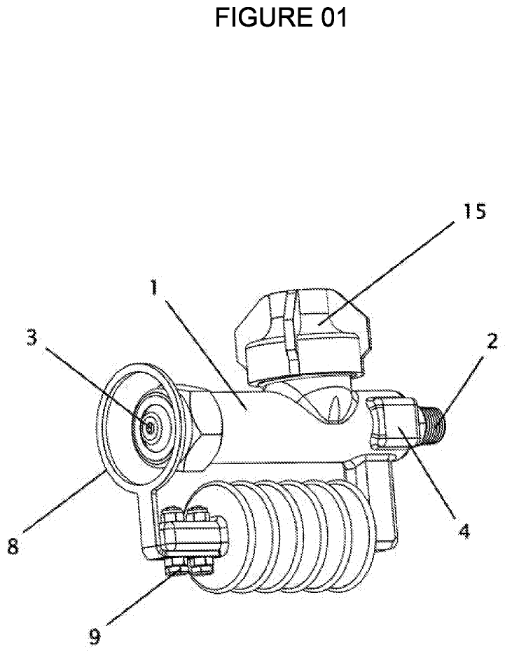

FIG. 2—shows a perspective and frontal view of the standard spray nozzle arrangement;

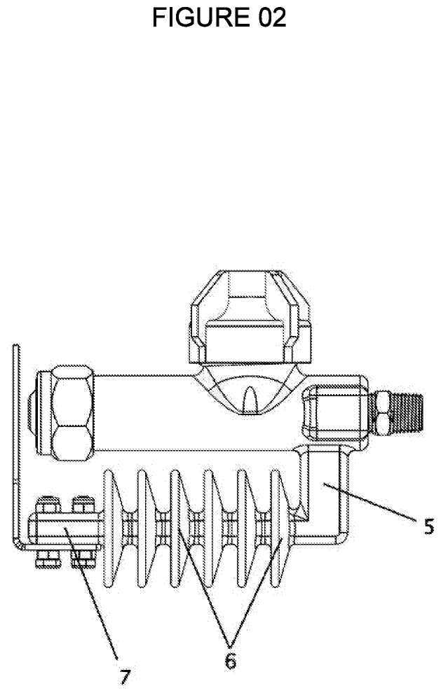

FIG. 3—shows a perspective and frontal view of the proposed spray nozzle arrangement with variation using a ceramic nozzle;

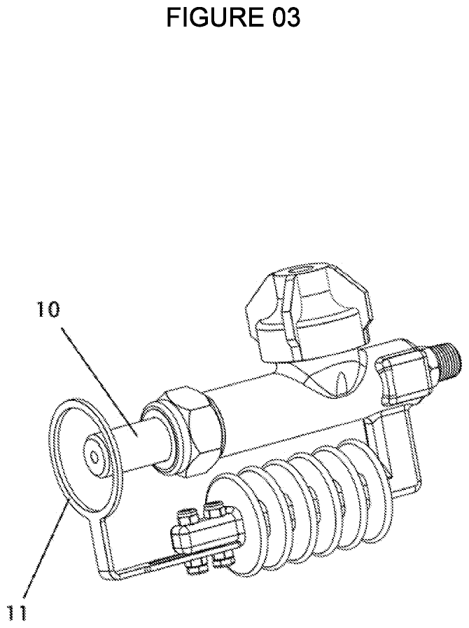

FIG. 4—shows a perspective and frontal view of the proposed spray nozzle arrangement with variation using a ceramic nozzle;

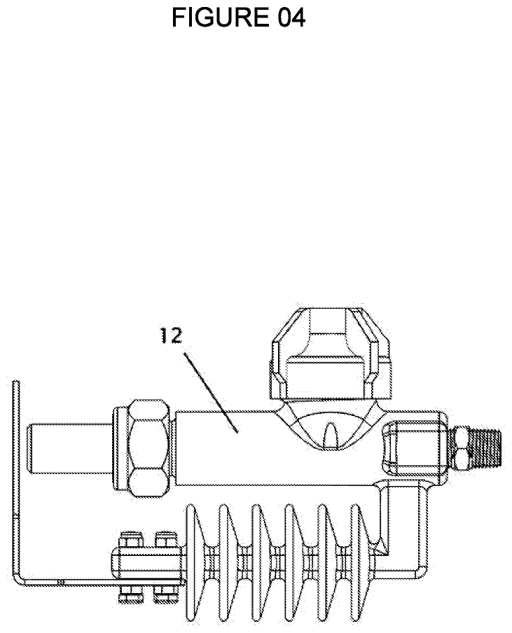

FIG. 5—shows perspectives of the proposed arrangement using the fan tip;

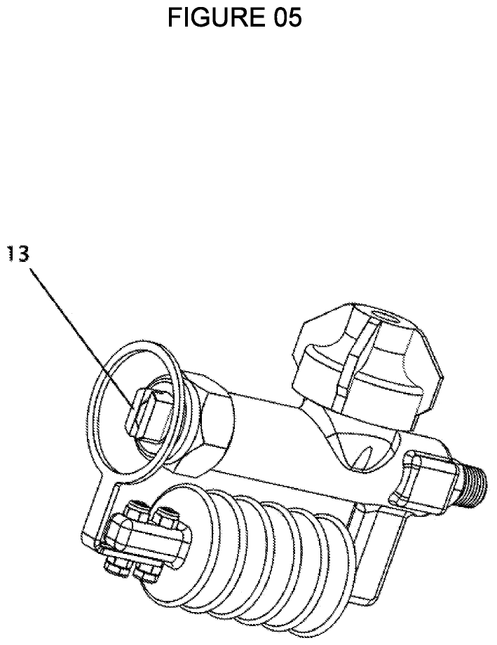

FIG. 6—shows perspectives of the proposed arrangement using the fan tip;

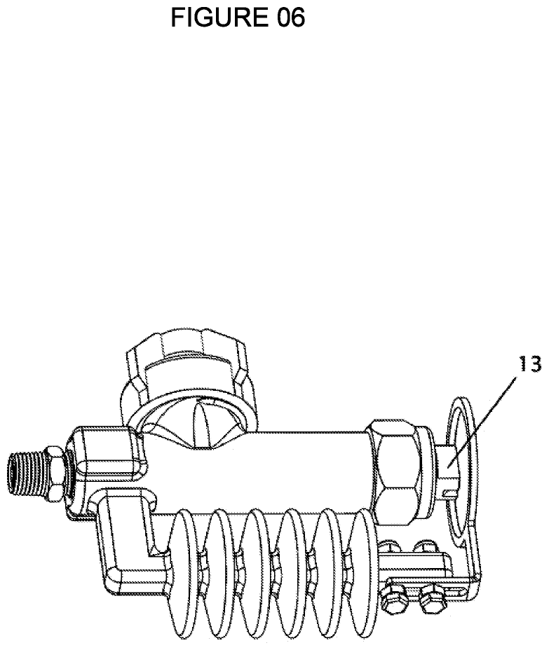

FIG. 7—shows the front view of a variation of the proposed construction arrangement, where the induction ring is in the shape of a multi-pierced cylinder;

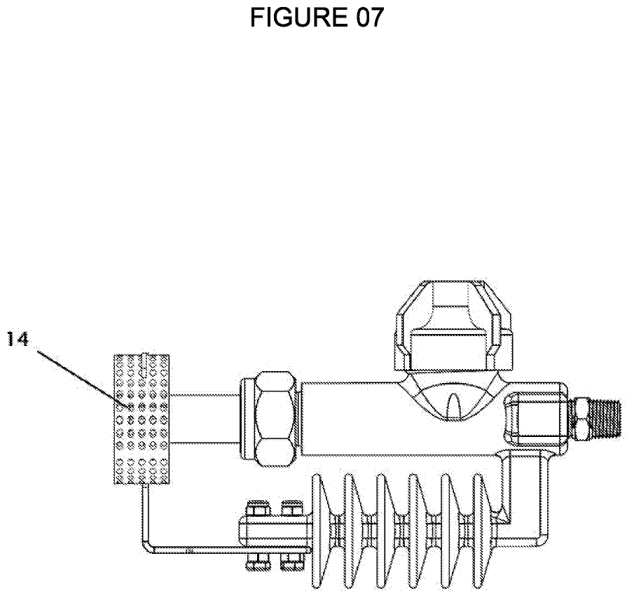

FIG. 8—shows the frontal view of a variation of the proposed construction arrangement, where the fins of the extender are arranged in pairs facing each other; and

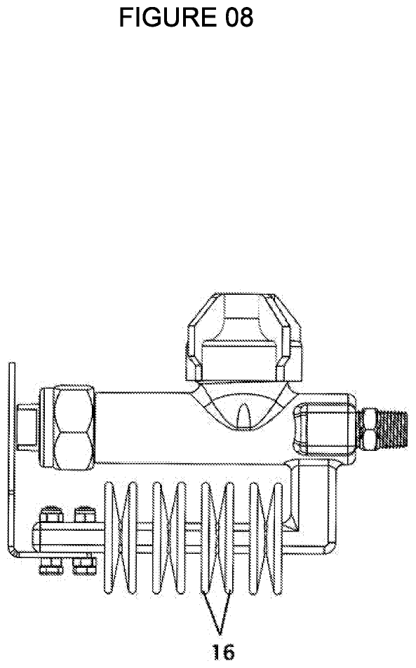

FIG. 9—shows the front view of a variation of the proposed construction arrangement, where the induction ring is in the shape of a cylinder.

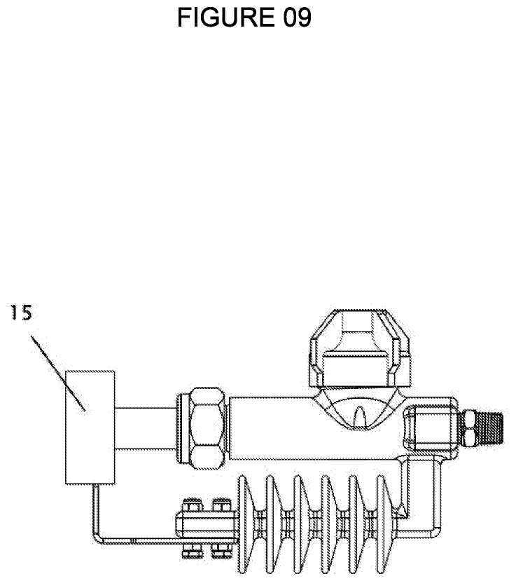

### DETAILED DESCRIPTION OF THE INVENTION

A preferred embodiment of the utility model employs a cylindrical body (1) containing an anti-drip system (15); said cylindrical body (1) having a thread (2) at the end connecting with the spray bar (not shown), at the other end, the spray nozzle itself (3); being that just below the thread (2) there is the projection (4) to thread the spray nozzle on the spray bar, an extension in the shape of an “L” (5) that protrudes from the threaded end (2); containing in the intermediate region a plurality of fins (6) and in the distal portion to the thread (2) a terminal (7), where the induction ring (8) is fastened by means of screws (9); these screws hold the high voltage cable (not shown).

The constructive arrangement allows the use of an extensive tip (10), where the induction ring (11) is further away from the cylindrical body (12).

Another variation occurs with the use of the fan tip (13) that allows flat- type electrostatic spraying.

Also, assembly is possible using an induction ring in the form of a multi-perforated cylinder (14), a cylinder without perforations (15) and an assembly of the fins in pairs facing each other (16).

1- Constructive arrangement applied to electrostatic spray nozzles for agricultural aircraft and helicopters comprising:
a cylindrical body (1) containing an anti-drip system (15) said cylindrical body (1) having a thread (2) at the end connecting with the spray bar (not shown), at the other end, the spray nozzle itself (3) being that just below the thread (2) there is the projection (4) to thread the spray nozzle on the spray bar, an extension in the shape of an “L” (5) that protrudes from the threaded end (2) containing in the intermediate region a plurality of fins (6) and in the distal portion to the thread (2) a terminal (7), where the induction ring (8) is fastened by means of screws (9) with the high voltage cable.

2- Constructive arrangement according to claim 1 characterized in that the constructive arrangement allows the use of an extensive tip (10), where the induction ring (11) is further away from the cylindrical body (12).

3- Constructive arrangement according to claim 1 characterized by having a variation with the use of the fan tip (13).

4- Constructive arrangement according to claim 1 characterized by having an assembly using an induction ring in the form of a multi-perforated cylinder (14);
a cylinder without perforations (15) and;
an assembly of the fins in pairs facing each other (16).
